(19) United States
(12) Patent Application Publication
(10) Pub. No.: US 2017/0321990 A1
(43) Pub. Date: Nov. 9, 2017

(54) TRUE SIGHT VIDEO CAMERA FOR HANDGUNS

(71) Applicants: Charles Taylor, Lincoln, CA (US); Rex Marks, Lincoln, CA (US)

(72) Inventors: Charles Taylor, Lincoln, CA (US); Rex Marks, Lincoln, CA (US)

(21) Appl. No.: 15/146,899

(22) Filed: May 5, 2016

(51) Int. Cl. F41C 27/00; H04N 5/225; H04N 5/33; H04N 5/77

(52) U.S. Cl. CPC F41C 27/00; H04N 5/772; H04N 5/2253; H04N 5/33

(57) ABSTRACT

The “True Sight Video Camera” is a firearm attachable, high capacity, specialized, automatic video recording camera for helping the police and military to record critically important criminal actions day or night.

It contains special Day and Infra Red lenses to accomplish recording automatically, not only the actions but, also the surrounding environment.

The use of this device is intended for domestic use in the protection of public safety.

### FIELD OF THE INVENTION

This invention relates to such a video camera device which has been specifically invented for law-enforcement agencies using handguns.

### CROSS-REFERENCE RELATED APPLICATIONS

This automatic video recording device is specifically designed for handguns used by law enforcement officers to record such actions, which could lead to the apprehension of criminals involved in the commission of criminal acts. Currently, there is no special video recording device of this kind known to the inventors. This device could not only record the criminal actions, but also aid in the preservation of human life. The U.S. current patent Classification for such devices is: 348/61

Current International Class: AO1M 31/100 (20060101)

The following are references to prior applications built for guns:

| Pat. No. | Date of Issue | Inventor |
|---|---|---|
| 4,454,454 | June 1984 | Valentine |
| 3,427,102 | February 1969 | Wade |
| 4,630,911 | December 1986 | Paul |
| 4,835,621 | May 1989 | Black |
| 5,711,104 | January 1998 | Schmitz |
| 5,834,676 | November 1998 | Elliot |
| 5,944,041 | August 1999 | Kitchen |
| 6,070,355 | June 2000 | Day |
| 6,556,248 | April 2003 | Holmberg |
| 7,194,204 | March 2007 | Gordon |

### BACKGROUND OF THE INVENTION

The usage of digital video camera technology has been continually increasing over the last 15 to 20 years. The need for using video cameras for responding to and preventing crime is also increasing. Getting credible information; how the criminal action has been prevented or handled by a police officer, has become more and more necessary. As such, a is desirable to provide a device which would 1) objectively record the “live” actions of a criminal element and 2) capture the actions of the engaging law enforcement officer. Therefore, it is the primary goal for this invention to provide a recording device that captures audio and video signals, day and night, of law enforcement encounters with potential criminal offenders. Key to the success of this device will be its compact, design that Incorporates a high-resolution, wide angle lens and infra-red capabilities to accommodate activity in varied lighting conditions. Presently, there is no such device available that could be easily attached to a handgun and deployed to capture the detail of law enforcement engagements. The video pictures taken by this unique device could be used later for review to provide evidence in a criminal investigation, insights for administrative and policy compliance, or critical detail necessary for improved training practices. The “True Sight Camera” (TSC) has been invented mainly for law enforcement personnel, but may also be utilized by security agencies requiring accurate, real time event history of encounters in the field. The accuracy of real-time recordings can also provide critical information necessary in maintaining the public's safety as well as the safety of law enforcement personnel responding to critical and potentially lethal incidents.

### SUMMARY OF THE INVENTION

The objectives and the purpose of the True Sight Video Camera (TSVC) are met by the built-in characteristics of the device. The design provides for continuous and effective control of the device by activating automatically upon deployment from a secure holster to efficiently record and maintain sound and video recording of enforcement action. The two-lens structure and the microphone allow the recordings to be retained on a media that may be downloaded and/or stored for evidentiary purposes. Also, be noted that lowering the gun from a horizontal to a vertical position will allow the recording to cease.

The inventors are confident that this invention will critical information necessary to resolve challenges as to the appropriateness and use of potentially lethal force in the apprehension of suspected criminal offender. Specifically, the recordings can provide answers to lethal encounters between law enforcement and the public.

This small TSC can be attached to existing handguns most commonly deployed by law enforcement agencies and retain audio and video data on a miniature memory card or similar media storage. The “True Sight Video Camera” will provide answers to questions most commonly asked following a lethal force encounter.

### DESCRIPTIONS OF CONCEPTUAL VIEWS PROVIDED

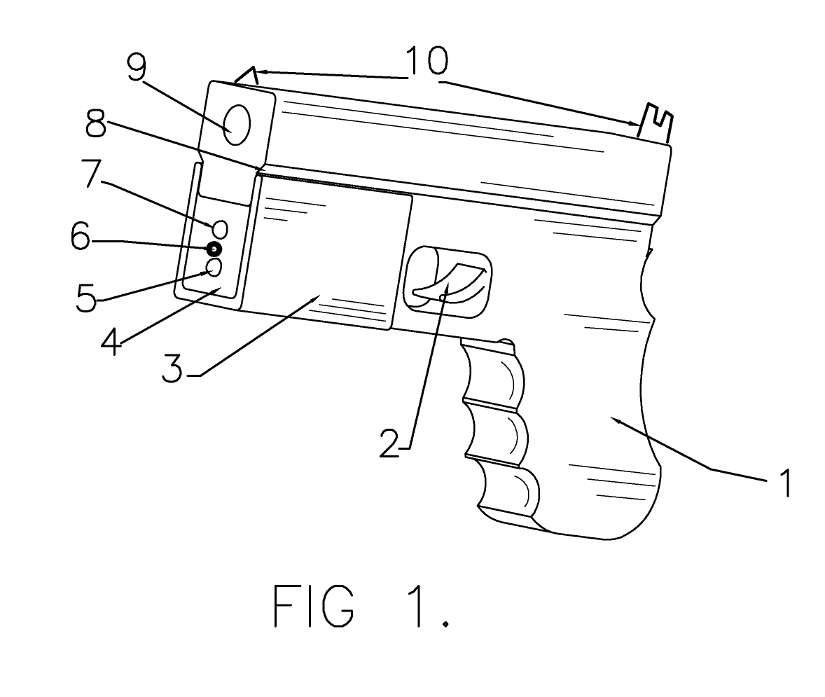

FIG. 1 shows the left side of a handgun where the audio/video camera has been attached. Where number 1 is the handle, number 2 is the pistol trigger of the hand gun. Number 3 is the recording device hull. Number 4 shows the video-audio unit sitting in the hull. Number 5 shows the infra-red (IR) lens. Number 6 is the microphone. Number 7 is the regular lens built-in to the video/audio unit of TSVC. Number 8 indicates a rail being on both sides of the device. Number 9 is the barrel of the gun. Number 10 indicates the gun-sight.

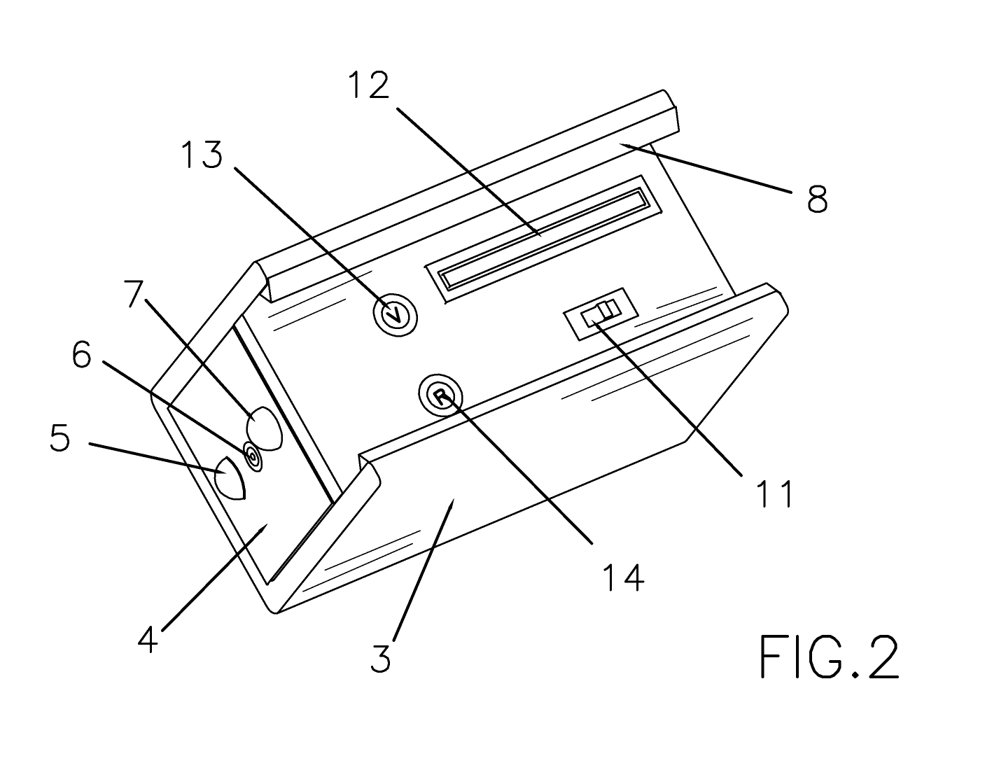

FIG. 2. Indicate the TSVC unit detached from the handgun. All the main parts, which are indicated on FIG. 1 have the same numbers. Number 11 shows the internal main switch. Number 12 indicates the input-slot of the recording media. Number 13 is an indicator light which can produce three lights: green, yellow and red for showing the available capacity of the battery. Number 14 is a green/red light for indicating the recording media condition.

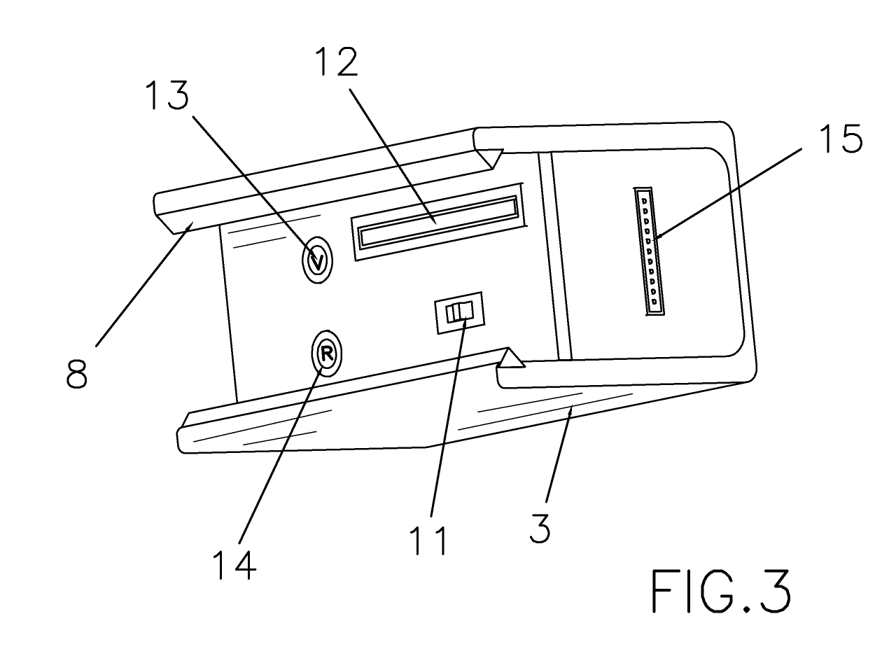

FIG. 3 is similar to FIG. 2, but it is more tilted for to see the back side of the TSVC device where Number 15 depicts the battery charging socket.

Naturally, a common, regular charging device will be used for periodic battery charge, but it is not a subject of this application.

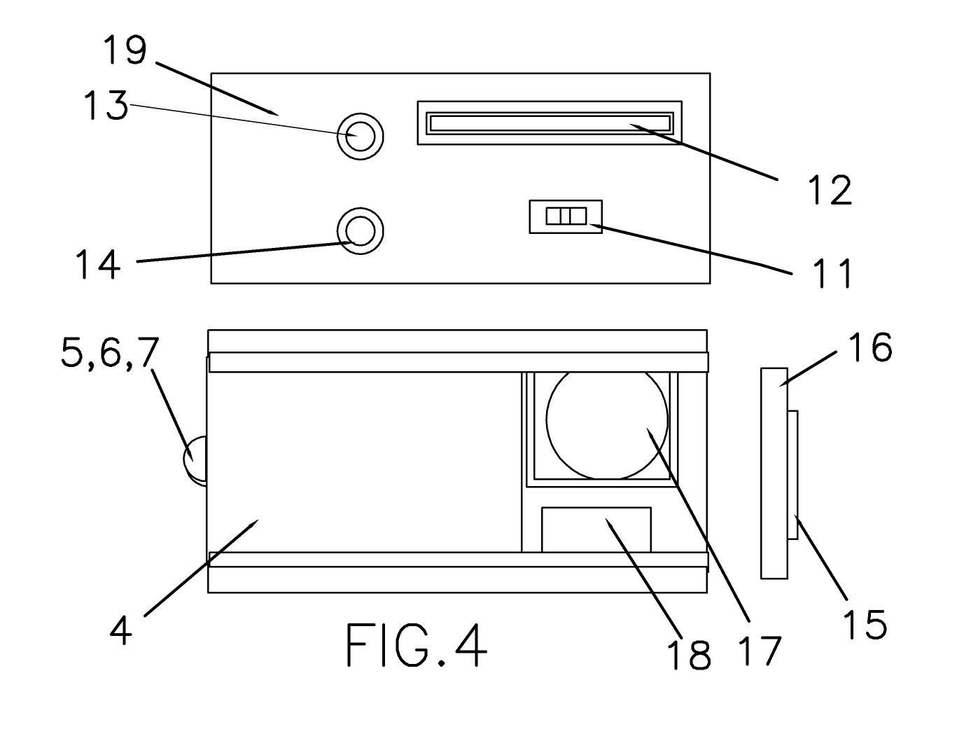

FIG. 4. is a top view, where the top cover, Number 19, is removed making visible the main parts of the device. Here Number 6 indicates the back plate where Number 15 is the battery charging socket. Number 17 is the rechargeable battery pack and number 18 is the position sensor.

All other numbers indicate the same parts of the device described in the previous Figures.

### DETAILED DISCLOSURE OF THE INVENTION

The TSVC is mainly an electronic device containing a miniature video camera unit; having a fixed regular and Infra-Red lens, and a microphone The infra-red lens helps to take pictures in low light conditions. The device purposely has no viewfinder and no display monitor that would distract the user attention from the action. In addition, the device has an action-controlling sensor and a rechargeable battery. The battery supplies the necessary electrical power to the device. One miniature light, capable of producing green, yellow and a red light, mounted on the top plate of the device indicates the condition of the battery, meaning to be good, medium charged or exhausted. There is also a small light; green/red is on the top plate for the indication of the recording media capacity condition, where red means: battery to be exhausted. Operating the TSYC device is very simple and safe.

Once the battery is charged and an empty recording media is inserted into the device, it can be turned on and attached, slipped onto the handgun by attaching to the standard rail system. While TSVC is carried on the handgun and in the holster, it is not activated; it “sleeps.” Lifted it out from the holster and raised close to the horizontal position the position sensor will turn on the device and it will run until the gun will be lowered to vertical position. The person carrying the gun should do nothing. The whole picture taking action works automatically and independent of who is handling the gun.

After an important action had been recorded, the unit can be removed from the gun and recording media taken out for inspection. The unit records automatically when the gun is raised to eye level or close to horizontal position. The TSC will shut down when the gun is lowered close to vertical position. The recording function is not always on. This way, the battery power is saved and economized for a future action. Naturally, the recording media should be replaced after each recorded action and the battery recharged or replaced.

WE CLAIM:

1. A miniature Video Camera device for the purpose of recording video and sound information onto a recording media purposely having no viewfinder and no display monitor.

2. An electronic video recording device which can be attached to a pistol or handgun having a rail-track for providing a secure attachment.

3. Video camera recording device having a switch to turn on and of its automatic function.

4. (canceled)

5. (canceled)

6. (canceled)

7. (canceled)

8. (canceled)

9. (canceled)

10. (canceled)

11. (canceled)

12. (canceled)
